(19) United States
(12) Patent Application Publication
(10) Pub. No.: US 2014/0300742 A1
(43) Pub. Date: Oct. 9, 2014

(54) CAMERA MODULE FOR VEHICLE

(71) Applicant: Sang Yeal Han, Seoul (KR)

(72) Inventor: Sang Yeal Han, Seoul (KR)

(73) Assignee: LG INNOTEK CO., LTD., Seoul (KR)

(21) Appl. No.: 14/358,180

(22) PCT Filed: Sep. 4, 2012
(86) PCT No.: PCT/KR2012/007074

§ 371 Date: May 14, 2014

(30) Foreign Application Priority Data
Nov. 18, 2011 (KR) 10-2011-0120699

(51) Int. Cl. H04N 5/225; H04N 7/18

(52) U.S. Cl. CPC H04N 5/2251; H04N 7/183
USPC 348/148

(57) ABSTRACT

A camera module is provided, the camera module including a camera module body (110) for installing an image sensor therein, a cover member (120) coupled to an upper side of the camera module body (110), and a fixing unit (130) integrally formed with the cover member (120) to fix the cover member and the camera module body to the vehicle.

### TECHNICAL FIELD

The teachings in accordance with exemplary embodiments of this invention relate generally to a camera module.

### BACKGROUND ART

Recently, a camera module is widely and frequently used for obtaining an image by the influence of sophistication and automation of vehicular parts. For non-limiting examples, camera modules are used for front and rear monitoring cameras and for black boxes in vehicles. In order to install a camera module at a front or a rear side of a vehicle, a separate bracket member for arranging the camera module on a proper position of the vehicle must be provided.

Structures for fixing a camera are known in the art. For example, Korea Laid-Open Patent Application No. 2010-0000956 discloses a structure configured to fix a camera. The structure, albeit not a configuration for fixing a camera module, includes a configuration for installing an angle-adjustable camera using a bracket. Furthermore, Korea registered Patent No.: 10-0912082 (registered on Aug. 6, 2009) discloses a configuration in which a vertically-tiltable camera module is fixed at a rear side of a vehicle using a bracket.

In a case a camera module is installed on a vehicle body using a bracket, there may be generated an instance where an optical axis of the camera module and a center of the bracket are not aligned in the course of coupling the bracket to an external housing of the camera module. In this instance, there occurs a problem where the camera module cannot capture an image clearly, even if the optical axis is precisely aligned inside the camera module.

Furthermore, a separate bracket is disadvantageously needed to additionally increase a unit price of the bracket, and a mold manufacturing cost for manufacturing the bracket.

### DISCLOSURE OF INVENTION

### Technical Problem

Accordingly, embodiments of the present invention may relate to a camera module for vehicle that substantially obviates one or more of the above disadvantages/problems due to limitations and disadvantages of related art, and it is an object of the present invention to provide a camera module for vehicle improved in structure to enable the camera module to be directly installed to a vehicle body without recourse to a separate fixing bracket.

Technical problems to be solved by the present invention are not restricted to the above-mentioned, and any other technical problems not mentioned so far will be clearly appreciated from the following description by skilled in the art.

### Solution to Problem

In order to accomplish the above object, the present invention provides a camera module for vehicle, the camera module comprising: a camera module body for installing an image sensor therein; a cover member coupled to an upper side of the camera module body; and a fixing unit integrally formed with the cover member to fix the cover member and the camera module body to the vehicle.

Preferably, but not necessarily, the fixing unit is a screw through hole coupled by a fixing screw.

Preferably, but not necessarily, a pair of fixing units is provided across the cover member.

Preferably, but not necessarily, the cover member and the fixing unit are injection-molded with resin material.

Preferably, but not necessarily, the cover member is installed at an approximate center with a lens.

Preferably, but not necessarily, the camera module body and the cover member are formed with same material.

Preferably, but not necessarily, the camera module body and the cover member are formed with different materials.

Preferably, but not necessarily, the camera module body and the cover member are coupled by press-fitting.

Preferably, but not necessarily, the camera module body and the cover member are adhesively coupled by an adhesive.

Preferably, but not necessarily, each of the camera module body and the cover member takes any one shape of a cylindrical form and a rectangular parallelepiped.

Preferably, but not necessarily, the cover member includes a tapered slope (inclined plane) from an uppermost surface, and a lateral surface connected to the slope to be in parallel with an optical axis of the image sensor.

Preferably, but not necessarily, the slope is symmetrically arranged about the optical axis.

Preferably, but not necessarily, the fixing unit is arranged at a position not interfering with the slope.

Preferably, but not necessarily, the fixing unit is formed at a lateral wall.

Preferably, but not necessarily, the fixing unit includes a head accommodation unit supported by a screw head of the fixing screw.

### Advantageous Effects of Invention

A camera module for vehicle according to the present invention has an advantageous effect in that the fixing unit is formed at one time with the cover member using same material to dispense with a separate bracket for fixing the camera module body, whereby an assembly process can be simplified.

### BRIEF DESCRIPTION OF DRAWINGS

The teachings of the present invention can be readily understood by considering the following detailed description in conjunction with the accompanying drawings, in which:

FIG. 1 is a schematic view illustrating a state where a camera module is installed on a vehicle according to an exemplary embodiment of the present invention; and

FIG. 2 is a perspective view illustrating the camera module of FIG. 1.

### BEST MODE FOR CARRYING OUT THE INVENTION

Now, the camera module for vehicle according to exemplary embodiments of the present invention will be described in detail with reference to the accompanying drawings.

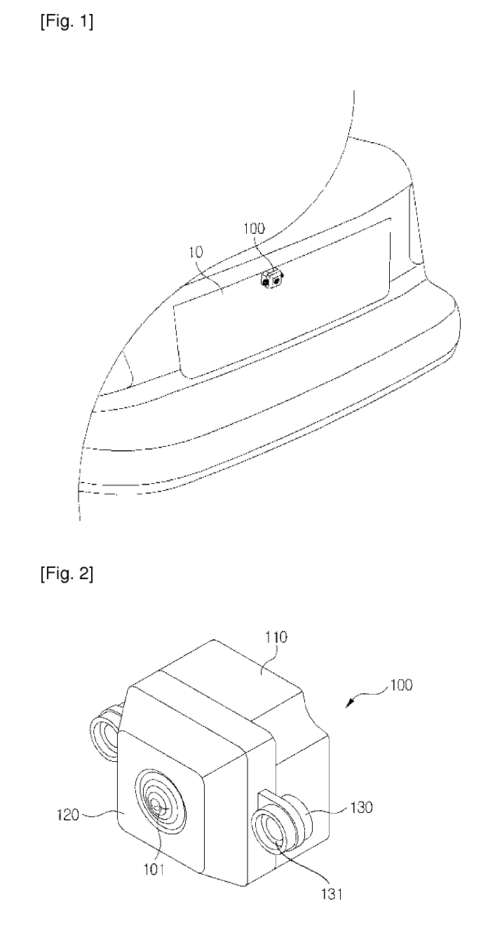

FIG. 1 is a schematic view illustrating a state where a camera module is installed on a vehicle according to an exemplary embodiment of the present invention, and

FIG. 2 is a perspective view illustrating the camera module of FIG. 1.

Referring to FIG. 1, a vehicle body is generally provided at a rear surface with a rear garnish for installing a vehicle emblem or a handle for opening a trunk, and a camera module (100) for vehicle may be provided near the rear garnish for monitoring a rear side of the vehicle, when necessary.

Recently, a variety of equipment is installed on a vehicle for improvement of user convenience, and a camera module for vehicle (herein after referred to as vehicle camera module) captures a dead zone where a driver s view fails to reach, and provides the driver with image information through a monitor inside the vehicle.

A vehicle camera module (100) is generally secured at an installation position for screw threads, and to this end, a separate bracket member was conventionally used. However, the vehicle camera module (100) according to an exemplary embodiment of the present invention is comprising a fixing unit (130) for fastening the screw without a separate bracket member being integrally formed with the vehicle camera module (100).

Meanwhile, the vehicle camera module (100) may be used as a front camera unit for capturing a front side of the vehicle and a rear camera unit for capturing a rear side of the vehicle. The front and rear camera units are generally configured with a same structure.

Referring to FIG. 2, the vehicle camera module (100) according to an exemplary embodiment of the present invention includes a camera module body (110), a cover member (120) and a fixing unit (130).

The camera module body (110) is formed in a cylindrical shape with a resin material, and installed therein with a PCB (Printed Circuit Board) mounted with an image sensor (not shown), and connected at a rear side with a cable member (not shown) for signal transmission.

The cover member (120) is coupled to the camera module body (110) to protect the image sensor against exposure to outside, and one or more sheets, if necessary, of lenses (101) is installed at a lens hole provided at a center of the cover member. An outside image may be transmitted to the image sensor through the lens (101). The camera module body (110) and the cover member (120) may be coupled by press-fitting or adhesively coupled by an adhesive.

A pair of fixing units (130) is provided across the cover member (120). According to the exemplary embodiment of the present invention, each of the fixing units is preferably provided in the same material as that of the cover member (120), and formed along with the cover member (120). For non-limiting example, in a case the cover member (120) is formed with resin material, a shape of the fixing unit (130) may be provided in a mold to simultaneously injection-mold the cover member (120) and the fixing unit (130).

### MODE FOR THE INVENTION

Meanwhile, the fixing unit (130) may be provided in a variety of shapes, and preferably provided in the shape of a screw hole through which a screw can penetratively coupled, as shown in FIG. 2.

Referring to FIG. 2 again, the fixing unit (130) is possibly formed with a head accommodation unit (131) supported by a screw head of the screw thread. The screw fastened to the fixing unit (130) serves to prevent the cover member (120) from being separated.

According to the abovementioned configuration, the fixing unit (130) and the cover member (120) are simultaneously formed with the same material to dispense with a separate bracket for fixing the camera module body (110), whereby an assembly process can be simplified.

Although the abovementioned exemplary embodiment of the present invention has illustrated a configuration where the fixing unit (130) and the cover member (120) are integrally formed, the present invention is not limited thereto. That is, albeit not shown in the drawing, the fixing unit (130) may be considered to be integrally formed with the camera module body (110). In this configuration, the cover member (120) apparently needs to be coupled to the camera module body (110) using a separate fixing means.

Furthermore, the cover member (120) and the fixing unit (130) may be formed with a metal material using a press working or a die casting, instead of injection-molding in resin material. The configuration using the press working or the die casting is derived from a need for forming the cover member (120) and the fixing unit (130) with a material robust to fragments or external shock due to being exposed to outside.

The previous description of the present invention is provided to enable any person skilled in the art to make or use the invention. Various modifications to the invention will be readily apparent to those skilled in the art, and the generic principles defined herein may be applied to other variations without departing from the spirit or scope of the invention. Thus, the invention is not intended to limit the examples described herein, but is to be accorded the widest scope consistent with the principles and novel features disclosed herein.

### INDUSTRIAL APPLICABILITY

The camera module according to the present invention has an industrial applicability in that it can be applied to a camera module of a vehicle, and applied to outside of a device.

1. A camera module for vehicle, the camera module comprising:
a camera module body for installing an image sensor therein;
a cover member coupled to an upper side of the camera module body; and
a fixing unit integrally formed with the cover member to fix the cover member and the camera module body to the vehicle.

2. The camera module of claim 1, wherein the fixing unit is a screw through hole coupled by a fixing screw.

3. The camera module of claim 1, wherein a pair of fixing units is provided across the cover member .

4. The camera module of claim 1, wherein the cover member and the fixing unit are injection-molded with resin material.

5. The camera module of claim 1, wherein the cover member is installed at an approximate center with a lens.

6. The camera module of claim 1, wherein the camera module body and the cover member are formed with same material

7. The camera module of claim 1, wherein the camera module body and the cover member are formed with different materials.

8. The camera module of claim 1, wherein the camera module body and the cover member are coupled by press-fitting.

9. The camera module of claim 1, wherein the camera module body and the cover member are adhesively coupled by an adhesive.

10. The camera module of claim 1, wherein each of the camera module body and the cover member takes any one shape of a cylindrical form and a rectangular parallelepiped.

11. The camera module of claim 1, wherein the cover member includes a tapered slope (inclined plane) from an uppermost surface, and a lateral surface connected to the slope to be in parallel with an optical axis of the image sensor.

12. The camera module of claim 11, wherein the slope is symmetrically arranged about the optical axis.

13. The camera module of claim 12, wherein the fixing unit is arranged at a position not interfering with the slope.

14. The camera module of claim 13, wherein the fixing unit is formed at a lateral wall.

15. The camera module of claim 13, wherein the fixing unit includes a head accommodation unit supported by a screw head of the fixing screw.
